(19) United States
(12) Patent Application Publication
(10) Pub. No.: US 2013/0325151 A1
(43) Pub. Date: Dec. 5, 2013

(54) CONTROL SYSTEM WITH SOLID STATE TOUCH SENSOR FOR COMPLEX SURFACE GEOMETRY

(71) Applicant: Bahar N. Wadia, Bartlett, IL (US)

(72) Inventor: Bahar N. Wadia, Bartlett, IL (US)

(73) Assignee: UICO, LLC, Elmhurst, IL (US)

(21) Appl. No.: 13/881,326

(22) PCT Filed: Oct. 25, 2011
(86) PCT No.: PCT/US11/57702

§ 371 Date: Jun. 6, 2013

Related U.S. Application Data
(60) Provisional application No. 61/406,337, filed on Oct. 25, 2010.

(51) Int. Cl. G05B 15/02

(52) U.S. Cl. CPC G05B 15/02
USPC 700/85

(57) ABSTRACT

A solid-state touch sensing system integrated into a control element for a device or equipment. The control element may have complex surface geometry. The system is capable of determining real-time parameters indicative of the character of user contact with the control element, and generating control signals for controlling the device or equipment or providing information or warnings to a user of the equipment.

### RELATED APPLICATIONS

The application claims the benefit of U.S. Provisional Patent Application No. 61/406,337, filed Oct. 25, 2010, and entitled SOLID STATE TOUCH SENSOR FOR COMPLEX SURFACE GEOMETRY, said application being hereby fully incorporated herein by reference.

### FIELD OF THE INVENTION

The present invention relates to control systems for devices and equipment, and more specifically to touch sensing control systems for devices and equipment.

### BACKGROUND OF THE INVENTION

Solid-state touch sensing technologies like capacitive touch sensing, for discrete touch pads and multi-touch touch screens have gained widespread acceptance in products, ranging from cell phones to large display monitors, in recent years. The success of these technologies is a direct result of the improved user-interaction as experienced by the users.

One benefit to using a solid-state sensing technology is its virtually infinite life. Unlike mechanical alternatives, having requisite moving components that wear with time and repeated use, solid-state touch-sensing technologies have no such limitations. As such, they seldom fail and users do not need to worry about a broken user-interface. Solid-state touch sensors have previously been integrated underneath a single solid sealed surface, for example glass or molded plastic, making the sensitive components inside the product essentially immune to the outside environment. In contrast, while not impossible, this is very difficult and costly to achieve with traditional mechanical alternatives.

With a combination of infinite life and the ability to seal user-interfaces, capacitive sensing provides significant benefits for products that are used in harsh outdoors environments. To date, however, solid-state sensors have primarily been deployed in two dimensional planes, mainly driven by the use of capacitive sensors on touch screens and touch-pads. While there have previously been some implementations of capacitive sensors on complex planes, they are generally limited to individual touch-pads acting as digital binary switches.

Such implementations, however, have been capable of providing only limited information to the machine about the interaction of the human with the machine. For example, in a prior system implemented in a rail vehicle, the vehicle speed controller was fitted with a capacitive sensor to detect the presence of the driver's hand. If the hand was removed for more than a short time, the track brakes were activated to stop or slow down the vehicle. A drawback of this system, however, is that the system is only capable of detecting contact, not the manner or characteristics of the contact. An inattentive or negligent driver may avoid application of the brakes by simply resting a hand or other body part on the sensor while performing other activities, thus defeating the purpose of the system.

What is needed is a system that applies capacitive or other solid-state touch sensing technology to geometrically complex surfaces so that the system is capable of determining the character of the user contact with the surface in addition to simply detecting contact.

### SUMMARY OF THE INVENTION

Embodiments of the instant invention address the needs of the industry by providing a capacitive or other solid-state touch sensing system integrated into a control element with a geometrically complex surface, and in which the system is capable of determining the character of user contact with the element. “Geometrically complex surface,” for purposes of this application, is defined as a surface that is non-planar.

In one exemplary embodiment, the invention may include a vehicle steering wheel equipped with one or more solid-state sensors embedded inside the steering wheel that not only sense the presence of a driver's hand in a simple binary fashion, but also sense the area of coverage, the confirming grip, or a casual resting of the palm. If the driver's grip of the steering wheel loosens while the vehicle is in motion, the system can provide a warning to the driver to redirect the driver's attention to the task of driving, or might automatically reduce engine power or apply the vehicle brakes in certain circumstances.

Embodiments of the invention may include a continuous sensing surface underneath or on top of a geometrically complex surface. The sensing surface can detect not only a binary presence of the hand or other body part, but it can detect the contours of a hand, how tightly the hand wrapped around the surface, movement of the hand due to slippage, and other such characteristics of human contact with the surface. The implementation may embody a flexible carrier on to which are placed a number of sensors (capacitive, IR, heat, etc). The flexible carrier is designed to conform to the complex surface geometry. The sensors work in conjunction or independently to capture the complex but very revealing interaction of the human hand with that surface. The sensor data is consolidated in a processor for analysis and the resulting interaction information transferred to the machine for responsive action.

According to an embodiment, a control system for equipment includes a control device presenting a contact surface, a solid-state touch pad covering at least a portion of the contact surface of the control device, and a signal processor communicatively coupled with the solid-state touch pad, the signal processor programmed with an algorithm for determining at least one real-time parameter related to contact of the body of a user with the solid-state touch pad. The signal processor may be communicatively coupled with memory, and at least one predetermined threshold parameter may be defined and stored in the memory. Further, the signal processor may be programmed to compare the at least one real-time parameter with the at least one threshold parameter, and the signal processor may then transmit a signal indicative of whether the at least one threshold parameter is met by the at least one real-time parameter.

In an embodiment, the solid-state touch pad can be a capacitive touch pad. Further, the contact surface of the control device may have a complex geometry. The at least one real-time parameter may be an area of a region of user contact with the control device, include a position of a region of user contact on the control device, include a centroid of a region of user contact with the control device, include a duration of user contact with the control device, and/or include a magnitude of a shift in position of a region of user contact on the control device.

In embodiments of the invention, the control device may be selected from the group consisting of a joystick, a steering wheel, a control yoke, and a shift lever. In embodiments, the signal processor is programmed with an algorithm for determining a plurality of real-time parameters related to contact of the body of a user with the solid-state touch pad. In such embodiments, the signal processor may be communicatively coupled with memory, and a plurality of predetermined threshold parameters defined and stored in the memory, each predetermined threshold parameter corresponding to a separate one of the real-time parameters. Further, the signal processor may be programmed to compare each real-time parameter with the corresponding threshold parameter, and the signal processor may transmit signals indicative of whether each threshold parameter is met by its corresponding real-time parameter. In embodiments, the control system may further include a device controller communicatively coupled with the signal processor, the device processor adapted to control a piece of equipment.

In other embodiments, a method of controlling a vehicle or equipment includes disposing a solid-state touch pad over at least a portion of a user contact surface of a control device of the vehicle or equipment, communicatively coupling a signal processor with the solid-state touch pad, and programming the signal processor with an algorithm for determining at least one real-time parameter related to contact of the body of a user with the solid-state touch pad. The method can further include communicatively coupling the signal processor with memory, and storing at least one predetermined threshold parameter in the memory. The method can still further include programming the signal processor to compare the at least one real-time parameter with the at least one threshold parameter, and programming the signal processor to transmit a signal indicative of whether the at least one threshold parameter is met by the at least one real-time parameter.

In other embodiments, the method can include programming the signal processor with an algorithm for determining a plurality of real-time parameters related to contact of the body of a user with the solid-state touch pad. The method can further include communicatively coupling the signal processor with memory, and storing a plurality of predetermined threshold parameters in the memory, each predetermined threshold parameter corresponding to a separate one of the real-time parameters. The method can still further include programming the signal processor to compare each real-time parameter with the corresponding threshold parameter, and programming the signal processor to transmit signals indicative of whether each threshold parameter is met by its corresponding real-time parameter.

### BRIEF DESCRIPTION OF THE DRAWINGS

The invention may be more completely understood in consideration of the following detailed description of various embodiments of the invention in connection with the following drawings, in which:

FIG. 1 is an isometric cutaway view of a joystick according to an embodiment of the invention;

FIG. 2 is a block diagram of a control system according to an embodiment of the invention;

FIG. 3 is a flowchart diagram of an exemplary process flow according to an embodiment of the invention;

FIG. 4 is an isometric view of the joystick embodiment of FIG. 1, depicting contact regions resulting from a user's grip on the joystick;

FIG. 5 is an isometric view of the joystick of FIG. 5, depicting contact regions resulting from a user's tightened grip on the joystick;

FIG. 6 is an isometric view of the joystick of FIG. 5, depicting a contact region resulting from a user's accidental contact with the joystick;

FIG. 7 is an isometric view of a steering wheel according to an embodiment of the invention;

FIG. 8 is an isometric view of the steering wheel embodiment of FIG. 7, depicting contact regions resulting from a user's grip on the wheel; and

FIG. 9 is an isometric view of the steering wheel embodiment of FIG. 7, depicting contact regions resulting from a user's grip on the wheel, with one of the regions shifting as a result of a slipping of the user's hand.

While the present invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

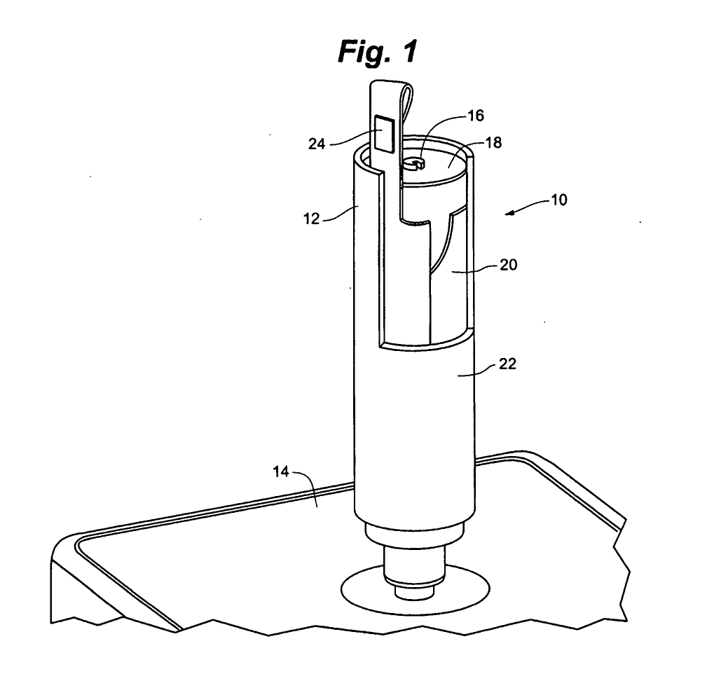

According to an embodiment of the invention depicted in FIG. 1, control device 10 generally includes joystick 12 and spring-loaded positioning pad 14. Joystick 12 generally includes shaft portion 16, spacer 18 surrounding shaft portion 16, solid-state sensing pad 20, outer covering 22, and embedded signal processor 24, which is communicatively coupled to solid-state sensing pad 20. Spring-loaded positioning pad 14 may be any such device as is commonly known in the art for maintaining joystick 12 biased toward a generally upright and centered position, and for transmitting control signals to a machine (not depicted) connected therewith, based on the directional movement of the joystick 12 and the magnitude of the movement. Notably, joystick 12 can have a surface with a complex outer contour, such as the cylindrical shape depicted, or other contours which may ergonomically conform to the shape of a user's hand. Solid-state sensing pad 20, in exemplary embodiments of the invention, may be a capacitive sensing pad capable of detecting multiple simultaneous touches.

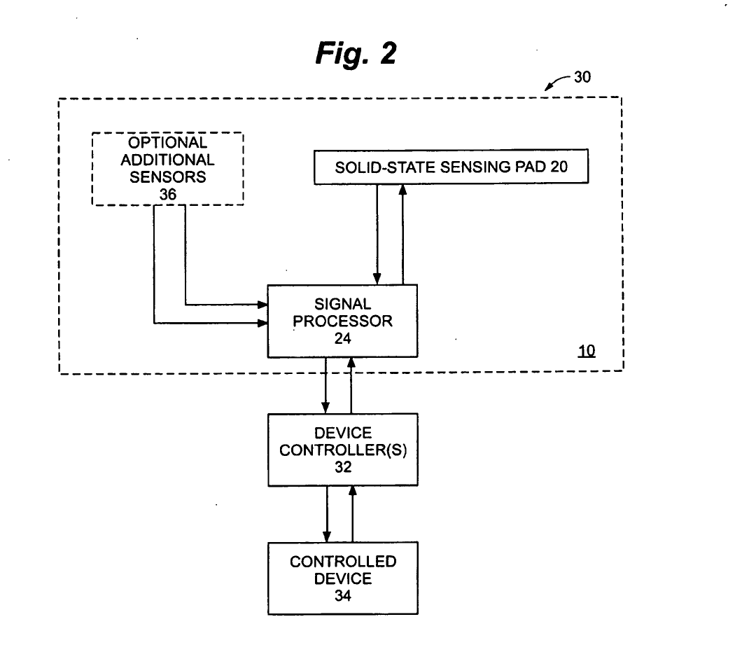

In FIG. 2, there is depicted a block diagram of a control system 30 according to an embodiment of the invention. System 30 generally includes control device 10, which includes device controller 32, and controlled device 34. As previously described for the joystick embodiment of FIG. 1, control device 10 generally includes solid-state sensing pad 20, signal processor 24, and may also include one or more other sensing devices 36, such as infrared (IR) or heat sensors. Signal processor 24 may be embedded in control device 10 as in the embodiment of FIG. 1, or may be located remotely from the other components of control device 10, and may be associated with memory, such as RAM, EEPROM, or other electronic memory circuitry (not depicted).

Device controller 32 generally includes a computer processor and any related peripherals, and is programmed with algorithms to control controlled device 34 and to receive and process signals from signal processor 24. For example, device controller 32 may be a transmission control module of a vehicle transmission, with controlled device 34 being the transmission. In such case, device controller 32 is typically programmed with algorithms to control and calculate and control how and when to change gears in the vehicle for optimum performance, fuel economy, and shift quality, using information supplied by remote sensors. In an embodiment of the invention, device controller 32 is also programmed with ability to recognize and process signals received from signal processor 24 that are indicative of a user's interaction with control device 10, as will be further described below.

It will be appreciated that device controller 32 and controlled device 34 can be any machine with associated control processor that is directed by user input. For example, device controller 32 can be a brake system controller for a vehicle, with the controlled device being the vehicle braking system. In other examples, device controller 32 can be a motion controller for equipment operated by joystick or yoke, or can be a processor for generating instrumentation, informational, or warning signals to an operator of the equipment. It will also be appreciated that signal processor 24 may interface with multiple device controllers 32 used for different purposes and controlling different devices or components of a vehicle or equipment.

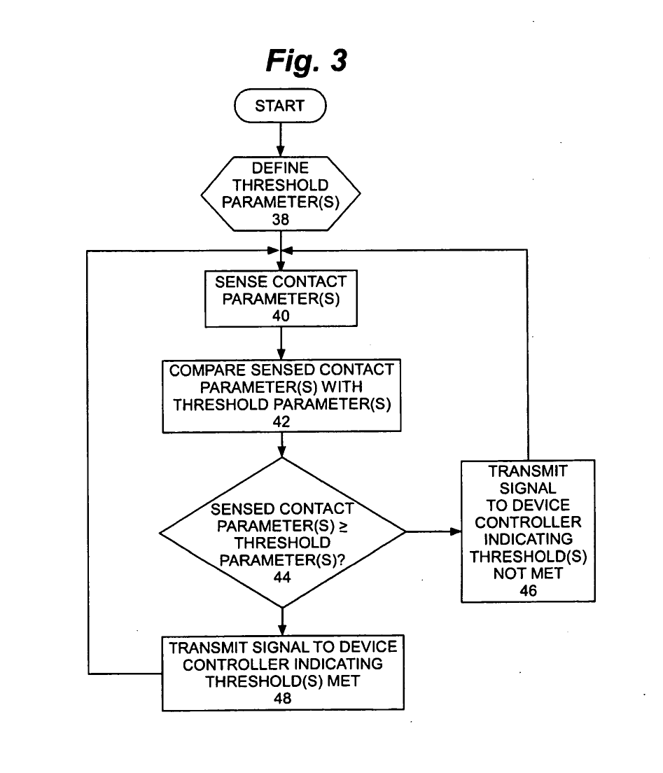

In FIG. 3, there is depicted a flowchart of an algorithm with which signal processor 24 is programmed according to an exemplary embodiment of the invention. In the depicted embodiment, threshold parameters are defined at step 38, and may be stored in the memory associated with signal processor 24. Such threshold parameters can include, for example, a desired areal coverage of user contact with solid-state touch pad 20, coordinates for the location of expected user contact with solid-state touch pad 20, a maximum permissible shift in the location of user contact with solid-state touch pad 20, and/or expected temporal duration of user contact with solid-state touch pad 20. It will be appreciated that any one of these parameters can be defined alone, or any combination of these or other such parameters can be defined.

At step 40, real-time parameters of user contact with solid-state touch pad 20 corresponding with the defined threshold parameters are determined with signal processor 24. For the examples given above, the areal coverage of user contact with solid-state touch pad 20 can be calculated as a sum or for separate individual areas of user contact, the coordinates and centroids of separate areas of user contact with solid-state touch pad 20 can be determined, shifts in location of the centroids of areas of user contact can be determined and tracked, and/or duration of user contact with solid-state touch pad 20 can be timed.

At steps 42 and 44, each of the real-time parameters determined at step 40 are compared with the corresponding thresholds defined at step 38. If a defined threshold parameter is not met by the corresponding real-time determined parameter, a signal is sent by signal controller 24 to device controller 32 indicating the threshold is not met at step 46. Alternatively, if the defined threshold parameter is met by the corresponding real-time determined parameter, a signal is sent by signal controller 24 to device controller 32 indicating the threshold is met at step 48. In either case, the process returns to step 40 and is continuously repeated.

It will be appreciated that as an alternative or in addition to the binary signals sent at steps 46 and 48, the values for real-time user contact parameters determined at step 40 can simply be transmitted as a signal to device controller 32 for processing. For example, values for the areal coverage of user contact with solid-state touch pad 20, the coordinates and centroids of separate areas of user contact with solid-state touch pad 20, shifts in location of the centroids of areas of user contact, and/or the duration of user contact with solid-state touch pad 20 can be transmitted to one or more device controllers 32.

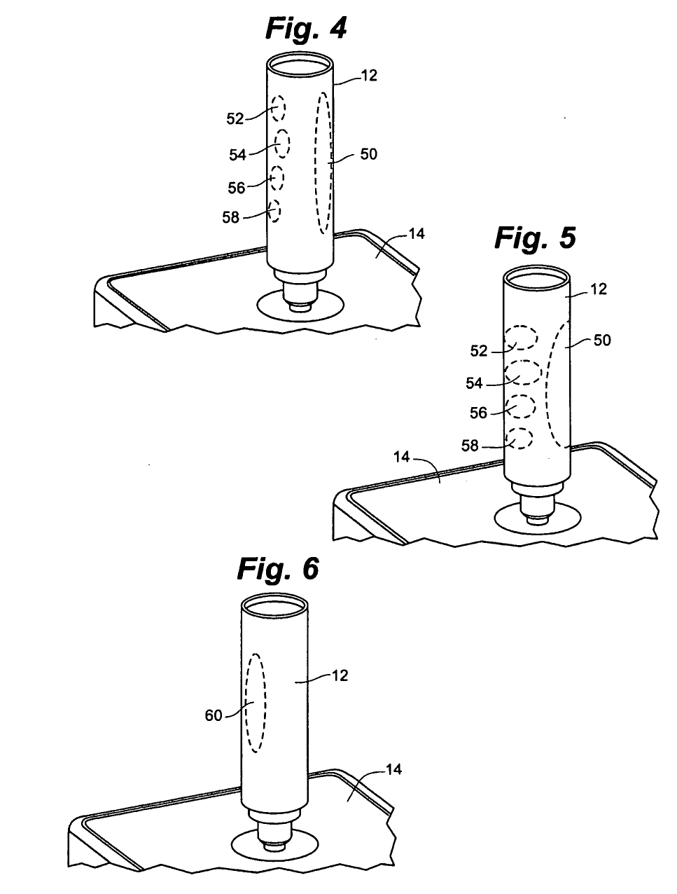

Referring now to FIGS. 4-6 for exemplary purposes, as a user grips joystick 12 with a hand (not depicted), solid-state sensing pad 20 is used to detect the various places at which a user's hand is in contact with the joystick 12, and signal processor may determine and calculate various parameters associated with the contact regions according to methods known in the art. For example, as depicted in FIG. 4, a user's palm may contact joystick 12 at contact region 50, while the user's index, middle, ring, and little fingers may contact joystick 12 at contact regions 52, 54, 56, 58, respectively. For each contact region 50, 52, 54, 56, 58, signal processor 24, which is communicatively connected with solid-state sensing pad 20 in joystick 12, may be used to determine or calculate the area of each. Further, the location of a centroid of each region can be calculated and rendered in a coordinate system such as polar coordinates or x-y-z coordinates. Also, the duration of contact can be timed for each region.

As discussed previously in relation to FIG. 3, any one or more of these detected or calculated parameters can be compared with defined threshold parameters to determine if the thresholds are met. For example, it may be desirable to set threshold parameters for the purpose of preventing accidental operation of joystick 12. In such an instance, with the joystick 12 gripped with a palm and fingers as depicted in FIG. 4, the total area of contact regions 50, 52, 54, 56, 58, can be summed and compared to a threshold value for user contact, using signal processor 24. With the threshold met, signal processor 24 can send an indicative signal to device controller 32, which in turn enables control input from the joystick 12 so that shifting of the joystick away from the vertical position against the bias applied by spring-loaded positioning pad 14 causes a control signal to be generated to the machine controlled by the joystick 12, the signal content depending on the direction and the degree to which the joystick 12 has been shifted. If the threshold value is not met, as for example if the user simply accidentally brushes against joystick 12 at contact region 60 as depicted in FIG. 6, signal processor 24 can transmit a signal to device controller 34, which in turn may be programmed to ignore control inputs from joystick 12.

In addition, if the user grips joystick 12 more tightly, the area of one or more of contact regions 50, 52, 54, 56, 58, may expand, as depicted in FIG. 5. In addition, where touch-pad 20 is a capacitive touch-pad, the degree of capacitive coupling at each may increase. Signal controller 24 can be programmed to recalculate the larger areas of contact regions 50, 52, 54, 56, 58, and/or detect an increase in capacitive coupling according to methods known in the art, and transmit a signal indicative of the tighter grip to device controller 32.

Hence, in embodiments of the invention, solid-state touch pad 20 can be an embedded capacitive touch sensor capable of detecting multiple touches, and the character of the user contact can be deduced by analyzing various parameters that can be sensed with the touch sensor. For example, the location of a user's fingers and palm can be deduced from the shapes and areas of each multiple touch. The centroid of each touch area can be calculated, and the movement of the centroids can be tracked in real time to enable determination of a shifting position of the hand, such as if the user's hand is slipping on the control element. The strength of the user's grip on the control element can be deduced from the areal size of each of the multiple touches, and the relative degree of coupling at each touch point.

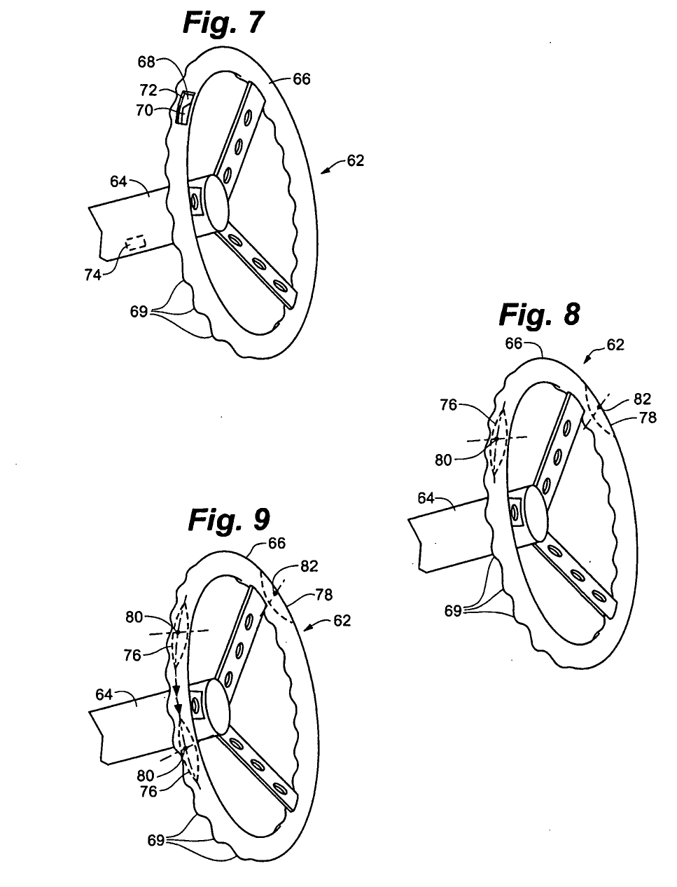

It will be appreciated that the information developed from analysis of the parameters sensed and determined from the touch sensor can be put to a vast array of uses in machine control algorithms. For example, as depicted in FIGS. 7-9, an automobile steering column 62 generally includes column 64 and wheel 66. Wheel 66 generally includes core 68 which may be partially or totally covered with solid-state sensing pad 70, in turn covered by outer covering 72. outer covering 22. Core 68 may have finger grips 69 defined therein. Signal processor 74, which is communicatively coupled to solid-state sensing pad 70, may be housed in column 64 as depicted, or in wheel 66. According to embodiments of the invention, solid-state sensing pad 70, in conjunction with signal processor 74, may be used to detect user contact at contact regions 76, 78. Again, the area of each contact region 76, 78, may be calculated, and the location of a centroid 80, 82, respectively, may be determined for each contact region 76, 78, may be determined according to methods known in the art. This information can be used, for example, to determine whether a driver is gripping the wheel with both hands at the proper “10 and 2 o'clock” locations on wheel 66 as depicted in FIG. 8. The duration of contact at each contact region 76, 78, can also be timed. If the driver removes one hand from the wheel for more than period of a few seconds (as for example to send a text message with a cellular phone), or if the driver's hand slips as indicated by a change in the location of contact region 76 centroid 80 (denoted by the arrows), a control algorithm in the automobile's on-board computer may be programmed to issue a voice warning to the driver to place both hands on the wheel. If the warning is not heeded within another period of time, the algorithm in the on-board computer may cut engine power or apply the vehicle brakes to slow or stop the vehicle.

In another example, a touch sensor according to the invention may be embedded in the transmission shift lever of an automobile and set to detect whether the user is gripping the shift lever in a certain appropriate way. If the lever is gripped in the appropriate way and then shifted from neutral to drive, an algorithm in the vehicle's on-board computer may be programmed to enable the transmission to carry out the shift as directed. If, however, the lever is not gripped in the appropriate way, as for example if the lever is simply knocked into drive by accident, the algorithm would cause the transmission to ignore the shift and remain in neutral.

It will be further appreciated that the invention is not limited to particular types of control elements, but may be used in any type of control element operated by contact with the body of a user. For example, without limitation, the invention may be embodied in joysticks, steering wheels, control yokes, levers, pushbuttons, other types of hand or foot controls, and any other type of control operated by contact.

It will also be appreciated that other types of sensors can be used instead of, or in addition to, capacitive touch sensors. For example, an infrared or heat sensor can be embedded in the control element to enable detection of touch magnitude or character by sensing the user's body heat. Such sensors may be used to augment the information gleaned from a capacitive touch sensor also embedded in the control element, or may be used alone in certain applications.

It will also be appreciated that the invention described herein may be applied to control elements having virtually any shape or size and solid state sensors may be applied at virtually any location on a control element. The solid state sensor may be made from flexible and/or resilient polymer material having suitable dielectric properties in the case of a capacitive touch pad, and may be formed so as to conform to the geometry of the control element. For example, the solid state sensor may be conformed to the generally cylindrical shape of a joystick as depicted herein in FIG. 1, or the shape of a steering wheel having an even more geometically complex shape as depicted in FIGS. 7-9. In other examples, solid state sensors may conform to the shape of a control yoke or shift lever, and may even be shaped to conform to finger grips formed therein.

The foregoing descriptions present numerous specific details that provide a thorough understanding of various embodiments of the invention. It will be apparent to one skilled in the art that various embodiments, having been disclosed herein, may be practiced without some or all of these specific details. In other instances, components as are known to those of ordinary skill in the art have not been described in detail herein in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A control system for equipment, comprising:
a control device presenting a contact surface;
a solid-state touch pad covering at least a portion of the contact surface of the control device; and
a signal processor communicatively coupled with the solid-state touch pad, the signal processor programmed with an algorithm for determining at least one real-time parameter related to contact of the body of a user with the solid-state touch pad.

2. The control system of claim 1, wherein the signal processor is communicatively coupled with memory, and wherein at least one predetermined threshold parameter is defined and stored in the memory.

3. The control system of claim 2, wherein the signal processor is programmed to compare the at least one real-time parameter with the at least one threshold parameter, and wherein the signal processor transmits a signal indicative of whether the at least one threshold parameter is met by the at least one real-time parameter.

4. The control system of claim 1, wherein the solid-state touch pad is a capacitive touch pad.

5. The control system of claim 1, wherein the contact surface has a complex geometry.

6. The control system of claim 1, wherein the at least one real-time parameter includes an area of a region of user contact with the control device.

7. The control system of claim 1, wherein the at least one real-time parameter includes a position of a region of user contact on the control device.

8. The control system of claim 1, wherein the at least one real-time parameter includes a centroid of a region of user contact with the control device.

9. The control system of claim 1, wherein the at least one real-time parameter includes a duration of user contact with the control device.

10. The control system of claim 1, wherein the at least one real-time parameter includes a magnitude of a shift in position of a region of user contact on the control device.

11. The control system of claim 1, wherein the control device is selected from the group consisting of a joystick, a steering wheel, a control yoke, and a shift lever.

12. The control system of claim 1, wherein the signal processor is programmed with an algorithm for determining a plurality of real-time parameters related to contact of the body of a user with the solid-state touch pad.

13. The control system of claim 12, wherein the signal processor is communicatively coupled with memory, and wherein a plurality of predetermined threshold parameters are defined and stored in the memory, each predetermined threshold parameter corresponding to a separate one of the real-time parameters.

14. The control system of claim 13, wherein the signal processor is programmed to compare each real-time parameter with the corresponding threshold parameter, and wherein the signal processor transmits signals indicative of whether each threshold parameter is met by its corresponding real-time parameter.

15. The control system of claim 1, further comprising a device controller communicatively coupled with the signal processor, the device processor adapted to control a piece of equipment.

16. A method of controlling a vehicle or equipment, the method comprising:
disposing a solid-state touch pad over at least a portion of a user contact surface of a control device of the vehicle or equipment;
communicatively coupling a signal processor with the solid-state touch pad; and
programming the signal processor with an algorithm for determining at least one real-time parameter related to contact of the body of a user with the solid-state touch pad.

17. The method of claim 16, further comprising communicatively coupling the signal processor with memory, and storing at least one predetermined threshold parameter in the memory.

18. The method of claim 17, further comprising programming the signal processor to compare the at least one real-time parameter with the at least one threshold parameter, and programming the signal processor to transmit a signal indicative of whether the at least one threshold parameter is met by the at least one real-time parameter.

19. The method of claim 16, further comprising programming the signal processor with an algorithm for determining a plurality of real-time parameters related to contact of the body of a user with the solid-state touch pad.

20. The method of claim 19, further comprising communicatively coupling the signal processor with memory, and storing a plurality of predetermined threshold parameters in the memory, each predetermined threshold parameter corresponding to a separate one of the real-time parameters.

21. The method of claim 20, further comprising programming the signal processor to compare each real-time parameter with the corresponding threshold parameter, and programming the signal processor to transmit signals indicative of whether each threshold parameter is met by its corresponding real-time parameter.
